(19) United States
(12) Patent Application Publication
(10) Pub. No.: US 2026/0310169 A1
(43) Pub. Date: Oct. 8, 2026

(54) TRAJECTORY OPTIMIZATION METHOD FOR SLOW TOOL SERVO TURNING OF COMPLEX CURVED SURFACES BASED ON CURVATURE GRADIENT CLUSTERING AND TRAJECTORY ERROR CONSTRAINTS

(71) Applicant: Harbin Institute of Technology, Harbin (CN)

(72) Inventors: Tao SUN, Harbin (CN); Xunlai LAI, Harbin (CN); Xuesen ZHAO, Harbin (CN); Tianji XING, Harbin (CN)

(21) Appl. No.: 19/682,632

(22) Filed: May 20, 2026

(30) Foreign Application Priority Data
Nov. 24, 2025 (CN) 202511726536.6

(51) Int. Cl. G05B 19/41; G05B 19/414

(52) U.S. Cl. CPC G05B 19/41; G05B 19/4145; G05B 2219/33099

(57) ABSTRACT

The present disclosure discloses a trajectory optimization method for Slow Tool Servo (STS) turning of complex curved surfaces based on curvature gradient clustering and trajectory error constraints, which belongs to the technical fields of ultra-precision cutting machining and Computer Numerical Control (CNC) trajectory optimization. The method comprises the following steps: Step 1, performing trajectory parameterization and initial equal-angle sampling; Step 2, calculating a trajectory curvature and curvature gradient; Step 3, performing automatic region classification based on curvature gradient density; Step 4, performing point deletion in the flat regions based on target error constraints; Step 5, performing global error validation and conducting local encryption of out-of-tolerance feedback; Step 6, outputting a final optimized trajectory point set.

### TECHNICAL FIELD

The present disclosure belongs to the technical fields of ultra-precision cutting machining and Computer Numerical Control (CNC) trajectory optimization, and relates to a trajectory generation and point set optimization method for Slow Tool Servo (STS) ultra-precision turning. Specifically, this disclosure relates to a trajectory optimization method for STS turning of complex curved surfaces based on curvature gradient clustering and trajectory error constraints.

### BACKGROUND

Slow tool servo (STS) turning is a core manufacturing technology for machining non-rotationally symmetric freeform optical components, and its machining accuracy relies heavily on high-precision trajectory planning. A typical STS turning process involves mapping the target surface onto a parametric curve defined by rotation angle and radial coordinate, discretizing the curve through sampling to obtain trajectory points, and then converting these points into Z-X-C three-axis motion commands executable by the Computer Numerical Control (CNC) system.

To achieve nanoscale surface sagittal height accuracy, industrial practices often adopt either high-density uniform sampling or an iterative sampling strategy based on prescribed trajectory accuracy as the dominant approaches for trajectory discretization. However, when applied to surfaces with complex features, such as sinusoidal grids, microlens arrays, and polynomial freeform surfaces, these methods exhibit certain limitations. On one hand, high-density uniform sampling (such as equal-angle or equal-arc length sampling) generates a large number of redundant points in large, gradually varying regions, resulting in excessively large machining program files and complicating both interpolation tasks and program management; on the other hand, for nanoscale accuracy requirements, although iterative sampling based on trajectory accuracy can ensure precision, it often significantly increases the computational time and resources required for trajectory generation and simulation, thereby reducing engineering efficiency. Furthermore, existing trajectory point generation and compression methods based on geometric features typically rely on absolute curvature values as criteria and depend on manually set thresholds, making it difficult to robustly distinguish genuinely complex regions that require high-density sampling from flat regions where redundant points can be safely reduced. Such methods are therefore not well-suited for surfaces with complex feature shapes. In addition, if large-scale global interpolation or verification is performed frequently in the process of deleting redundant point judgment and out-of-tolerance feedback point set encryption, the amount of calculation and memory occupation will rise sharply, thus reducing the engineering feasibility of the algorithm.

### SUMMARY

The present disclosure provides a trajectory optimization method for Slow Tool Servo (STS) turning of complex curved surfaces based on curvature gradient clustering and trajectory error constraints, this method is used to generate and optimize a tool motion trajectory for three-axis (Z-X-C) STS turning. This method is suitable for ultra-precision machining objects including optical freeform surfaces (such as aspheric surfaces, freeform surfaces, polynomial surfaces, and array surfaces with periodic microstructures).

An objective of the present disclosure is realized by the following technical schemes:
A trajectory optimization method for STS turning of complex curved surfaces based on curvature gradient clustering and trajectory error constraints includes the following steps:
Step 1, performing trajectory parameterization and initial equal-angle sampling:
Step 1-1, denoting a machined complex curved surface as a sagittal height function z=f(x,y), and describing a trajectory using polar coordinate system parameters (ρ, θ), where:

$$x ( θ ) = ρ ( θ ) cos θ , y ( θ ) = ρ ( θ ) sin θ$$

Where θ e is a polar angle parameter, ρ(θ) is a radial coordinate at polar angle θ, and x(θ) and y(θ) are coordinates in a rectangular coordinate system at polar angle θ;
taking a linear radial mapping:

$$ρ ( θ ) = \frac{{r}_{max}}{{θ}_{max}} θ , θ ∈ [ θ , {θ}_{max} ]$$

Where rₘₐₓ is a maximum radius of a workpiece, and θₘₐₓ is a total angle of a spiral trajectory;
Step 1-2, performing an initial sampling at equal-angle Δθ under a premise of satisfying a trajectory target error Δzₜₒₗ, then obtaining an initial trajectory point set [symbol] :

$$𝒫 = {\{ ( {ρ}_{i} , {θ}_{i} , {z}_{i} ) \}}_{i = 1}^{N} , {z}_{i} = f ( {ρ}_{i} cos {θ}_{i} , {ρ}_{i} sin {θ}_{i} )$$

Where ρᵢ is a radial coordinate of an initial trajectory point, θᵢ is a polar angle of the initial trajectory point, zᵢ is a sagittal height of the initial trajectory point, and Nis a number of initial equal-angle sampling points.
Step 2, calculating a trajectory curvature κ(θ) and curvature gradient G(θ):
Step 2-1, defining a trajectory space vector r(θ) in terms of the trajectory parameter θ, and defining derivative vectors r₁(θ) and r₂(θ):

$$r ( θ ) = [ \begin{matrix}x ( θ ) \\ y ( θ ) \\ z ( θ )\end{matrix} ] , {r}_{1} ( θ ) = \frac{dr}{d θ} , {r}_{2} ( θ ) = \frac{{d}^{2} r}{d {θ}^{2}}$$

Then the trajectory curvature κ(θ) is:

$$κ ( θ ) = \frac{‖ {r}_{1} ( θ ) \times {r}_{2} ( θ ) ‖}{{‖ {r}_{1} ( θ ) ‖}^{3}}$$

Step 2-2, denoting an arc length differential as ds=∥r₁(θ)∥dθ, and integrating with respect to θ over the arc length yields

$$s ( θ ) = {\int }_{0}^{θ} ‖ {r}_{1} ( u ) ‖ du ,$$

then the curvature gradient G(θ) is:

$$G ( θ ) = \vert \frac{d κ}{ds} \vert$$

Step 2-3, according to the initial trajectory point set ′P, calculating a curvature gradient set {G(θᵢ)};
Step 3, performing automatic region classification based on curvature gradient density:
Step 3-1, constructing a one-dimensional kernel density estimation for the curvature gradient set {G(θᵢ)}, and calculating a probability density function estimate \hat{p}_{G}(g):

$${\hat{p}}_{G} ( g ) = \frac{1}{nh} {\sum }_{i = 1}^{n} K ( \frac{g - {G}_{i}}{h} )$$

Where g is a curvature gradient value at which the probability density is currently being estimated; n is total number of samples in a curvature gradient sequence; Gᵢ is a curvature gradient value at an i-th sample point;

$$K ( \frac{g - {G}_{i}}{h} )$$

is a kernel function; and h is a bandwidth;
Step 3-2, using a derivative method to detect local valleys on \hat{p}_{G}(g) for determining one or more segmentation thresholds {T_{G,i}};
Step 3-3, taking a first significant valley T_{G} as a dividing threshold for complex/flat division:

$$Region category ( {θ}_{i} ) = \{ \begin{matrix}complex region , & G ( {θ}_{i} ) > {T}_{G} \\ flat region , & G ( {θ}_{i} ) \leq {T}_{G}\end{matrix}$$

Step 3-4, merging continuous segments of the obtained category sequence: For segments shorter than a minimum length threshold Lₘᵢₙ, merging them into a more similar adjacent side based on a median or mean of neighboring segments, thereby eliminating isolated short segments caused by noise;
Step 4, performing point deletion in the flat regions based on target error constraints:
Step 4-1, for each continuous interval [θₐ, θ_{b}] classified as flat, using interval endpoints to construct a linear interpolation reconstruction function \hat{z}(θ), and defining a local interpolation error function of the interval:

$${E}_{[ a , b ]} ( θ ) = \vert f ( ρ ( θ ) cos θ , ρ ( θ ) sin θ ) - {\hat{z}}_{[ a , b ]} ( θ ) \vert$$

Where f(ρ(θ)cos θ), ρ(θ)sin θ) is a theoretical sagittal height at the polar angle θ, and \hat{z}_{[a, b]}(θ) is a sagittal height obtained through linear interpolation at the polar angle θ;
A basis for point deletion is:

$${max}_{θ ∈ ( {θ}_{a} , {θ}_{b} )} {E}_{[ a , b ]} ( θ ) \leq Δ {z}_{tol}$$

Step 4-2, using a following numerical decision logic to efficiently find a maximum internal interval that can be deleted:
(1) Starting from a left endpoint θₐ of the interval, attempt to quickly find a right endpoint θ_{b} through exponential expansion such that the local maximum error of the interval [θₐ, θ_{b}] is less than the trajectory target error Δzₜₒₗ; if an expansion fails, determine a maximum deletable right endpoint via binary search between a last successful position and a failed position;
(2) Marking all deletable interior points within this maximum interval as “deletable”; then, starting from this right endpoint, continue repeating the above steps moving rightward until the end of the interval is reached;
Step 5, performing global error validation and conducting local encryption of out-of-tolerance feedback:
Step 5-1, after completing point deletion in flat regions, performing a global error validation on an entire optimized trajectory point set, if there exists a set of out-of-tolerance positions Θₒᵥₑᵣ={θ:E(θ)>Δzₜₒₗ}, mapping these out-of-tolerance θ positions to their corresponding optimized point intervals [θₖ, θₖ₊₁];
Step 5-2, for each identified interval, dynamically determining a number of points inns, k according to its local maximum out-of-tolerance E_{max, k}, and uniformly inserting these points within the interval to encrypt a grid;
Step 5-3, repeating a global validation-local encryption process until the global error satisfies max E(θ)≤Δzₜₒₗ;
Step 6, outputting a final optimized trajectory point set:
Outputting a final optimized trajectory point set

$${𝒫}_{opt} = {\{ ( {ρ}_{i}^{opt} , {θ}_{i}^{opt} , {z}_{i}^{opt} ) \}}_{i = 1}^{{N}_{opt}} ,$$

where

$${ρ}_{i}^{opt}$$

is a radial coordinate of the optimized trajectory point,

$${θ}_{i}^{opt}$$

is a polar angle of the optimized trajectory point, and

$${z}_{i}^{opt}$$

is a sagittal height of the optimized trajectory point, in three-axis STS turning,

$${ρ}_{i}^{opt}$$

corresponds to a motion position of an X-axis,

$${θ}_{i}^{opt}$$

corresponds to an angular position of a C-axis, and

$${z}_{i}^{opt}$$

corresponds to a motion position of a Z-axis. Based on an actual dynamic limits of a machine tool, determining a synchronized speed of a shaft system and generating a complete machining G-code.

Compared with the existing technologies, the present disclosure has the following advantages:
1, To address an issue of a large number of redundant points generated by high-density sampling with equal-angle or equal-arc length in flat regions, the present disclosure provides a method for significantly compressing a number of trajectory points without reducing machining accuracy (i.e., maintaining a maximum sagittal height error within a preset threshold), thereby reducing a size of a CNC program. A desired objective is to achieve a notable point compression rate while preserving or improving a maximum interpolation error upper bound of an original sampling.
2, Existing methods based on an absolute value of curvature lack sufficient discriminative power on multidirectional or periodically varying curved surfaces, and cannot reliably distinguish between locally sharp regions that require high-density retention and flat regions where points can be deleted. The present disclosure introduces a more discriminative geometric quantity (a rate of change of curvature along arc length-curvature gradient) and combines it with data-driven clustering or density estimation methods to achieve automatic segmentation of trajectory regions with different complexity levels, thereby providing a reliable basis for targeted point deletion or retention decisions.
3, Point deletion decisions must be guided by error constraints, aiming to both avoid a risk of exceeding the preset sagittal height limit at any individual location and keep verification and restoration costs within an engineering-acceptable range. To this end, the present disclosure devises an error-driven point deletion and restoration process: In flat regions, efficient local error inspection (vectorized local sampling, exponential expansion combined with binary search, etc.) is employed for rapid assessment; after deletion, a one-time global fine validation is performed, and for segments where the error is found to exceed a tolerance, minimal local point insertion is carried out until convergence, thereby forming a reliable closed-loop error control.
4, The present disclosure may automatically and robustly partition a target curved surface into “complex regions” and “flat regions” while ensuring that a maximum allowable sagittal height error of the trajectory is not exceeded. In the flat regions, an error-driven local point deletion strategy is applied; in out-of-tolerance regions, a minimal local encryption is performed, which significantly reduces the number of points in a final CNC trajectory, the program volume, and a trajectory preparation time.

### BRIEF DESCRIPTION OF THE DRAWINGS

FIG. 1 is an overall flow chart of a trajectory optimization method for Slow Tool Servo (STS) turning of complex curved surfaces based on curvature gradient clustering and trajectory error constraints;

FIG. 2 is a sinusoidal grid surface model;

FIG. 3 is a theoretical error distribution of the original equal-angle trajectory;

FIG. 4 is a theoretical error distribution of the optimized trajectory.

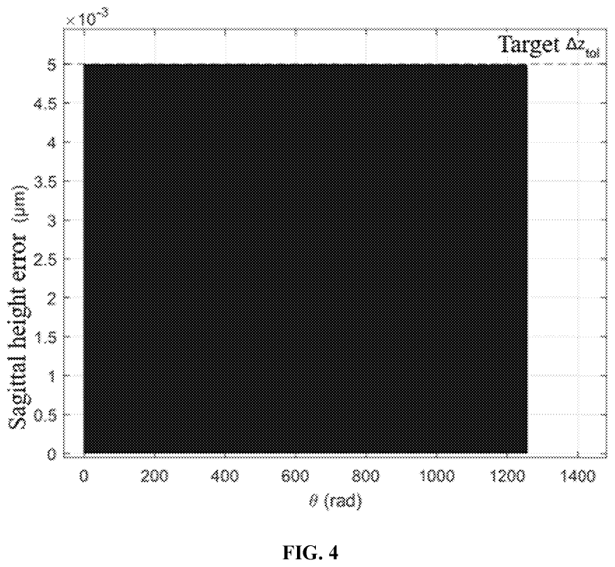

### DETAILED DESCRIPTION

The following is a further explanation of the technical scheme of the present disclosure in combination with the drawings, but it is not limited to this. Any modification or equivalent replacement of the technical scheme of the present disclosure, without breaking away from the spirit and scope of the technical scheme of the present disclosure, should be covered in the protection scope of the present disclosure.

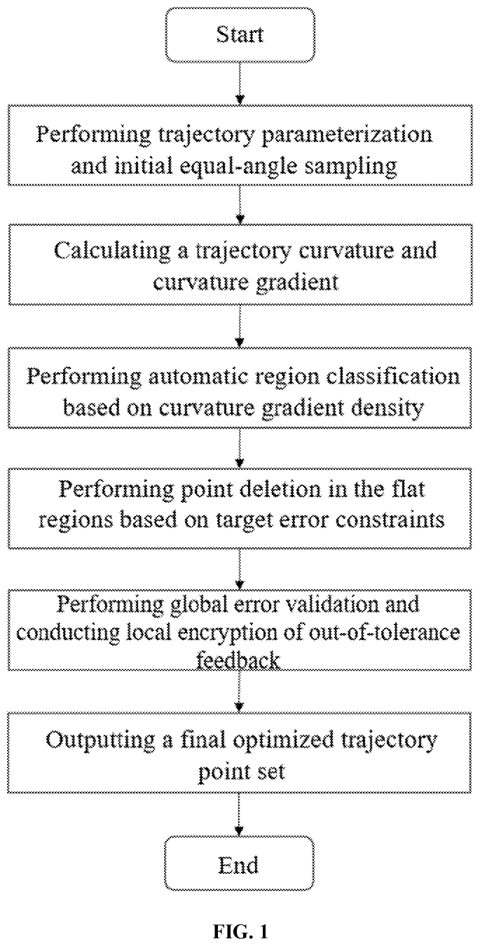

The present disclosure provides a trajectory optimization method for Slow Tool Servo (STS) turning of complex curved surfaces based on curvature gradient clustering and trajectory error constraints. The proposed method first maps the target surface to polar coordinates and constructs an equiangular spiral as the initial trajectory, it then calculates the spatial curvature gradient of the trajectory and uses clustering to automatically divide the trajectory into complex regions and flat regions based on the curvature gradient; in the flat regions, an error-constrained exponential expansion combined with binary search is adopted as the point deletion strategy. Subsequently, a one-time global validation is performed, and minimal local encryption is applied to the few regions that exceed the error tolerance. Ultimately, significant trajectory point compression is achieved while ensuring that the maximum sagittal height error does not exceed a preset threshold. As shown in FIG. 1, the method specifically includes the following steps:
Step 1, trajectory parameterization and initial equal-angle sampling:
A machined complex curved surface is denoted as a sagittal height function z=f(x,y), and a trajectory is described using polar coordinate system parameters (ρ, θ), where:

$$x ( θ ) = ρ ( θ ) cos θ , y ( θ ) = ρ ( θ ) sin θ \qquad ( 1 )$$

Where θ is a polar angle parameter, ρ(θ) is a radial coordinate at polar angle θ, and x(θ) and y(θ) are the coordinates in the rectangular coordinate system at polar angle θ;
A linear radial mapping is taken:

$$ρ ( θ ) = \frac{{r}_{max}}{{θ}_{max}} θ , θ ∈ [ θ , {θ}_{max} ] \qquad ( 2 )$$

Where rₘₐₓ is a maximum radius of the workpiece, and θₘₐₓ is the total angle of a spiral trajectory.
The initial sampling is performed at equal-angle Δθ under a premise of satisfying a trajectory target error Δzₜₒₗ, then the initial trajectory point set [symbol] is obtained:

$$𝒫 = {\{ ( {ρ}_{i} , {θ}_{i} , {z}_{i} ) \}}_{i = 1}^{N} , {z}_{i} = f ( {ρ}_{i} cos {θ}_{i} , {ρ}_{i} sin {θ}_{i} ) \qquad ( 3 )$$

Where ρᵢ is a radial coordinate of the initial trajectory point, θᵢ is a polar angle of the initial trajectory point, zᵢ is a sagittal height of the initial trajectory point, and Nis the number of initial equal-angle sampling points.
Step 2, the trajectory curvature κ(θ) and curvature gradient G(θ) are calculated:
A trajectory space vector r(θ) is defined in terms of the trajectory parameter θ, and derivative vectors r₁(θ) and r₂(θ) are defined:

$$r ( θ ) = [ \begin{matrix}x ( θ ) \\ y ( θ ) \\ z ( θ )\end{matrix} ] , {r}_{1} ( θ ) = \frac{dr}{d θ} , {r}_{2} ( θ ) = \frac{{d}^{2} r}{d {θ}^{2}} \qquad ( 4 )$$

Then the trajectory curvature is:

$$κ ( θ ) = \frac{‖ {r}_{1} ( θ ) \times {r}_{2} ( θ ) ‖}{{‖ {r}_{1} ( θ ) ‖}^{3}} \qquad ( 5 )$$

The arc length differential is denoted as ds=∥r₁(θ)∥dθ, and by integrating with respect to θ over the arc length,

$$s ( θ ) = {\int }_{0}^{θ} ‖ {r}_{1} ( u ) ‖ du$$

is obtained, then the curvature gradient G(θ) is defined as:

$$G ( θ ) = \vert \frac{d κ}{ds} \vert \qquad ( 6 )$$

According to the initial trajectory point set P, the curvature gradient set {G(θᵢ)} is calculated and used for subsequent clustering analysis.
Step 3, automatic region classification is performed based on curvature gradient density:
The one-dimensional kernel density estimation is constructed for the curvature gradient set {G(θᵢ)}, and the probability density function estimate \hat{p}_{G}(g) is obtained according to Formula (7):

$${\hat{p}}_{G} ( g ) = \frac{1}{nh} {\sum }_{i = 1}^{n} K ( \frac{g - {G}_{i}}{h} ) \qquad ( 7 )$$

Where g is a curvature gradient value at which the probability density is currently being estimated; n is the total number of samples in a curvature gradient sequence; Gᵢ is a curvature gradient value at the i-th sample point;

$$K ( u ) = \frac{1}{\sqrt{2 π}} {e}^{- {u}^{2} / 2}$$

is a kernel function (the Gaussian kernel is adopted here), where

$$u = \frac{g - {G}_{i}}{h} ;$$

h=1.06σ_{G}n^{-1/5} is the bandwidth, which controls the smoothness of the kernel density estimation, and σ_{G} is the standard deviation of the curvature gradient samples.

The derivative method is used to detect local valleys on \hat{p}_{G}(g) for determining one or more segmentation thresholds {T_{G,l}}.

The first significant valley T_{G} is taken as a dividing threshold for complex/flat division

$$Region category ( {θ}_{i} ) = \{ \begin{matrix}complex region , & G ( {θ}_{i} ) > {T}_{G} \\ flat region , & G ( {θ}_{i} ) \leq {T}_{G}\end{matrix} \qquad ( 8 )$$

Subsequently, continuous segment merging is performed on the obtained category sequence: Segments shorter than the minimum length threshold Lₘᵢₙ are merged into the more similar adjacent side based on the median or mean of the neighboring segments, thereby eliminating isolated short segments caused by noise.
Step 4, point deletion is performed in the flat regions based on target error constraints:
For each continuous interval [θₐ, θ_{b}] classified as flat, a linear interpolation reconstruction function \hat{z}(θ) is constructed by using the interval endpoints, where the endpoints are determined by the retained trajectory points. The local interpolation error function of the interval is then defined:

$${E}_{[ a , b ]} ( θ ) = \vert f ( ρ ( θ ) cos θ , ρ ( θ ) sin θ ) - {\hat{z}}_{[ a , b ]} ( θ ) \vert \qquad ( 9 )$$

Where f(ρ(θ)cos θ), ρ(θ)sin θ) is a theoretical sagittal height at the polar angle θ, and \hat{z}_{[a, b]}(θ) is a sagittal height obtained through linear interpolation at polar angle θ;
A basis for point deletion is:

$${max}_{θ ∈ ( {θ}_{a} , {θ}_{b} ]} {E}_{[ a , b ]} ( θ ) \leq Δ {z}_{tol} \qquad ( 10 )$$

Following numerical decision logic is used to efficiently find the maximum internal interval that can be deleted:
(1) Starting from a left endpoint θₐ of the interval, attempt to quickly find the right endpoint θ_{b} through exponential expansion such that the local maximum error of the interval [θₐ, θ_{b}] is less than the trajectory target error Δzₜₒₗ; if the expansion fails, determine the maximum deletable right endpoint via binary search between the last successful position and a failed position;
(2) All deletable interior points within this maximum interval are marked as “deletable”; then, starting from this right endpoint, the above steps are continued to be repeated moving rightward until the end of the interval is reached.
Step 5, global error validation and local encryption of out-of-tolerance feedback:
After completing point deletion in flat regions, the global error validation is performed on the entire optimized trajectory point set. If there exists a set of out-of-tolerance positions Θₒᵥₑᵣ={θ:E(θ)>Δzₜₒₗ}, these out-of-tolerance θ positions are mapped to their corresponding optimized point intervals [θₖ, θₖ₊₁]. For each identified interval, the number of points n_{ins,k} is dynamically determined according to its local maximum out-of-tolerance E_{max,k} (e.g., by a proportional or piecewise function), and these points are uniformly inserted within the interval to encrypt the grid. The global validation and local encryption process is repeated until the global error satisfies max E(θ)≤Δzₜₒₗ.

This closed-loop mechanism ensures that the final output trajectory satisfies the target error requirement, and only local encryption is performed where necessary to avoid global over-increasing points.
Step 6, the final optimized trajectory point set is output:
The final optimized trajectory point set

$${𝒫}_{o p t} = {\{ ( {ρ}_{i}^{o p t} , {θ}_{i}^{o p t} , {z}_{i}^{o p t} ) \}}_{i = 1}^{{N}_{o p t}}$$

is output, where

$${ρ}_{i}^{o p t}$$

is a radial coordinate of the optimized trajectory point,

$${θ}_{i}^{o p t}$$

is a polar angle of the optimized trajectory point, and

$${z}_{i}^{o p t}$$

is a sagittal height of the optimized trajectory point, in three-axis STS turning,

$${ρ}_{i}^{o p t}$$

corresponds to a motion position of an X-axis,

$${θ}_{i}^{o p t}$$

corresponds to an angular position of a C-axis, and

$${z}_{i}^{o p t}$$

corresponds to a motion position of a Z-axis. Based on the actual dynamic limits of a machine tool, the synchronized speed of the shaft system is determined, and the complete machining G-code is generated.

### Embodiment

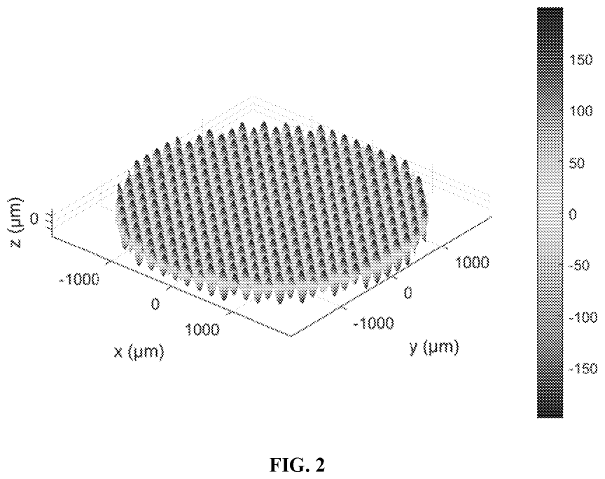

In this embodiment, trajectory point optimization is performed on the sinusoidal grid surface after tool compensation: z=f(x,y)=A sin(2πx/λₓ)+A sin(2πy/λ_{y}), with amplitude A=100 μm; spatial periods λx=λy=200 μm; circular workpiece radius rₘₐₓ=2 mm; allowable maximum sagittal height error zₜₒₗ=0.005 μm; number of spiral turns=200; the model of the sinusoidal grid surface is shown in FIG. 2.

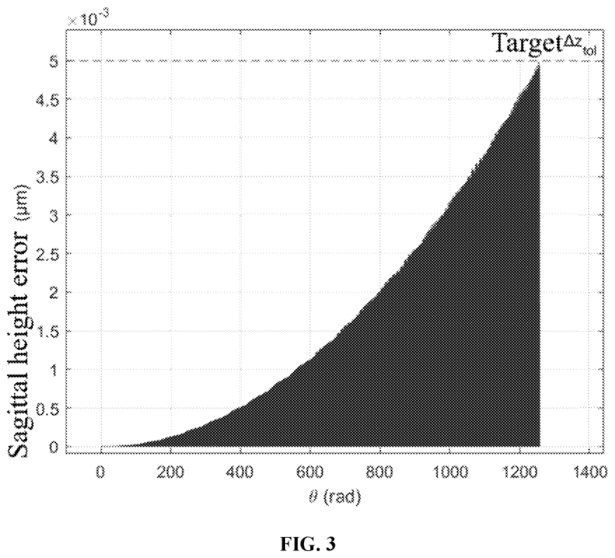

Firstly, according to the radius of the workpiece and the number of spiral circles required, the maximum angular range required on the polar angle is determined. Based on the maximum sagittal height error constraint, the maximum equal-angle step size is calculated to be 0.0183 degrees. According to Formulas (1), (2), and (3), the initial trajectory point set ′P is obtained as the input for subsequent optimization. At this stage, the number of trajectory points is 3971429, and the maximum sagittal height error is 0.00498 μm, the theoretical error distribution of the original equal-angle trajectory is shown in FIG. 3. This step ensures that the initial trajectory theoretically satisfies the given global upper bound of the target sagittal height error, thereby providing a reasonable starting point for subsequent point deletion.

Secondly, for the above initial trajectory point sequence [symbol] , the curvature sequence {k(θᵢ)} and the corresponding curvature gradient sequence {G(θᵢ)} along the parameter θ are calculated according to Formulas (4), (5), and (6). From the effective curvature gradient sample set after removing the first few points (to eliminate computational instability at the start of sampling), the probability density function of the curvature gradient distribution is estimated using one-dimensional kernel density estimation according to Formula (7). The local valley positions are automatically detected based on this density function, and the first significant valley is used as the division threshold; if no significant valley is detected, the sample median is used as the backup threshold. Using this threshold, the trajectory points are automatically divided into “complex regions” and “flat regions”. To eliminate short-term label fluctuations caused by noise, a short-segment merging strategy is applied to the label sequence: Segments whose length is smaller than a predetermined minimum length (0.5% of the sequence length and no less than 3 points) are merged into the adjacent more representative category based on the majority label of the neighboring segments or the approximate distance of the curvature gradient within the segment. After completing this step, a set of continuous “flat segment” index intervals is obtained for subsequent point deletion operations.

Thirdly, for each continuous segment judged as a “flat region”, point deletion is attempted according to the following efficient strategy: Starting from the left endpoint of the segment, the interval to be deleted is gradually expanded: the exponential expansion method is adopted to progressively increase the right index (that is, doubling the step size by 1, 2, 4, 8 . . . ) to quickly locate the boundary where the maximum sagittal height error is exceeded (if the error never exceeds the tolerance, expansion continues to the end of the segment). To control local detection cost, the upper limit of local detection points is set to 600, and long intervals are evaluated in a segmented manner. After the exponential expansion terminates, a binary search is performed between the last index satisfying the tolerance and the first index violating the tolerance to determine the maximum allowable right index for deletion, thereby identifying the maximum safe deletable interval. For the found deletable interval, points inside the interval (excluding the two endpoints) are marked for deletion; the process then continues from the next unprocessed point until the end of the segment. After processing the entire segment, the left and right endpoints are retained to ensure connectivity and boundary safety of the trajectory segment. After completing the initial point deletion for all smooth segments, an initial optimized point set is obtained. For this point set, if the global maximum error does not exceed the given tolerance, the optimization ends; otherwise, all out-of-tolerance positions are extracted, and each out-of-tolerance point is mapped to its corresponding optimization interval for local encryption.

Then, for each interval judged to be out of tolerance, local encryption is performed according to the following rules: Several isometric test points are taken inside the interval to calculate the maximum value of the true error in the interval, and the number of points to be inserted is determined according to the empirical rules (this embodiment is based on the ratio of interval error to tolerance, downward rounding is limited to between 1 and 5 points). These new points are inserted in the interval and merged them into the current optimization point sequence. After completing the encryption of all out-of-tolerance intervals, global validation is performed again. If the global error still exceeds the tolerance, the above positioning and encryption process is repeated until the error meets the requirement. This embodiment has undergone two local encryption iterations and finally meets the requirements of maximum sagittal height error, the number of optimized trajectory points is 1819587, and the compression rate reaches 54.18%.

Finally, the final optimized trajectory point set

$${𝒫}_{o p t} = {\{ ( {ρ}_{i}^{o p t} , {θ}_{i}^{o p t} , {z}_{i}^{o p t} ) \}}_{i = 1}^{{N}_{o p t}}$$

is output, in the three-axis STS turning,

$${ρ}_{i}^{o p t}$$

corresponds to a motion position of the X-axis,

$${θ}_{i}^{o p t}$$

$${z}_{i}^{o p t}$$

corresponds to an angular position of the C-axis, and Z corresponds to a motion position of the Z-axis, based on the actual dynamic limits of the machine tool, the synchronized speed of the shaft system is determined and the complete machining G-code is generated.

The judgment criteria, the number of local detection points, the short-segment merging threshold, and the local insertion strategy used in this embodiment may all be adjusted according to resource and speed requirements in engineering applications, so as to control the trade-off between compression ratio and computational overhead.

What is claimed is:

1. A trajectory optimization method for Slow Tool Servo (STS) turning of complex curved surfaces based on curvature gradient clustering and trajectory error constraints comprises the following steps:
Step 1, performing trajectory parameterization and initial equal-angle sampling;
Step 2, calculating a trajectory curvature c(θ) and curvature gradient G(θ), specific steps are as follows:
Step 2-1, defining a trajectory space vector r(θ) in terms of a trajectory parameter θ, and defining derivative vectors r₁(θ) and r₂(θ):
$$r ( θ ) = [ \begin{matrix}x ( θ ) \\ y ( θ ) \\ z ( θ )\end{matrix} ] , {r}_{1} ( θ ) = \frac{dr}{d θ} , {r}_{2} ( θ ) = \frac{{d}^{2} r}{d {θ}^{2}} ,$$
Wherein x(θ) and y(θ) are coordinates in a rectangular coordinate system corresponding to a polar angle θ;
then the trajectory curvature c(θ) is:
$$κ ( θ ) = \frac{‖ {r}_{1} ( θ ) \times {r}_{2} ( θ ) ‖}{{‖ {r}_{1} ( θ ) ‖}^{3}}$$
Step 2-2, denoting an arc length differential as ds=∥r₁(θ)∥dθ, and integrating with respect to θ over the arc length yields
$$s ( θ ) = {\int }_{0}^{θ} ‖ {r}_{1} ( u ) ‖ du ,$$
then the curvature gradient G(θ) is:
$$G ( θ ) = \vert \frac{d κ}{ds} \vert$$
Step 2-3, according to the initial trajectory point set [symbol] , calculating a curvature gradient set {G(θᵢ)};
Step 3, performing automatic region classification based on curvature gradient density, specific steps are as follows:
Step 3-1, constructing a one-dimensional kernel density estimation for the curvature gradient set {G(θᵢ)}, and calculating a probability density function estimate \hat{p}_{G}(g);
Step 3-2, using a derivative method to detect local valleys on \hat{p}_{G}(g) for determining one or more segmentation thresholds {T_{G,i}};
Step 3-3, taking a first significant valley T_{G} as a dividing threshold for complex/flat division:
$$Region catergory ( {θ}_{i} ) = \{ \begin{matrix}complex region , & G ( {θ}_{i} ) > {T}_{G} \\ flat region , & G ( {θ}_{i} ) \leq {T}_{G}\end{matrix}$$
Step 3-4, merging continuous segments of the obtained category sequence: for segments shorter than a minimum length threshold Lₘᵢₙ, merging them into a more similar adjacent side based on a median or mean of neighboring segments, thereby eliminating isolated short segments caused by noise;
Step 4, performing point deletion in the flat regions based on target error constraints, specific steps are as follows:
Step 4-1, for each continuous interval [θₐ, θ_{b}] classified as flat, using interval endpoints to construct a linear interpolation reconstruction function \hat{z}(θ), and defining a local interpolation error function of the interval:
$${E}_{[ a , b ]} ( θ ) = \vert f ( ρ ( θ ) cos θ , ρ ( θ ) sin θ ) - {\hat{z}}_{[ a , b ]} ( θ ) \vert$$
Wherein f(ρ(θ)cos θ),ρ(θ)sin θ) is a theoretical sagittal height at the polar angle θ, and \hat{z}_{[a, b]}(θ) is a sagittal height obtained through linear interpolation at polar angle θ;
a basis for point deletion is:
$${max}_{θ ∈ ( {θ}_{a} , {θ}_{b} )} {E}_{[ a , b ]} ( θ ) \leq Δ {z}_{tol}$$
Wherein Δzₜₒₗ is the trajectory target error;
Step 4-2, using a following numerical decision logic to efficiently find a maximum internal interval that can be deleted:
starting from a left endpoint θₐ of the interval, attempt to quickly find a right endpoint θ_{b} through exponential expansion such that the local maximum error of the interval [θₐ, θ_{b}] is less than the trajectory target error Δzₜₒₗ; if an expansion fails, determine a maximum deletable right endpoint via binary search between a last successful position and a failed position;
marking all deletable interior points within this maximum interval as “deletable”;
then, starting from this right endpoint, continue repeating the above steps moving rightward until the end of the interval is reached;
Step 5, performing global error validation and conducting local encryption of out-of-tolerance feedback;
Step 6, outputting a final optimized trajectory point set.

2. The trajectory optimization method for STS turning of complex curved surfaces based on curvature gradient clustering and trajectory error constraints according to claim 1, wherein the specific steps of Step 1 are as follows:
Step 1-1, denoting a machined complex curved surface as a sagittal height function z=f(x,y), and describing a trajectory using polar coordinate system parameters (ρ, θ), wherein:
$$x ( θ ) = ρ ( θ ) cos θ , y ( θ ) = ρ ( θ ) sin θ$$
Wherein θ is a polar angle parameter, ρ(θ) is a radial coordinate at polar angle θ, and x(θ) and y(θ) are the coordinates in a rectangular coordinate system at polar angle θ;
taking a linear radial mapping:
$$ρ ( θ ) = \frac{{r}_{max}}{{θ}_{max}} θ , θ ∈ [ 0 , {θ}_{max} ]$$
Wherein rₘₐₓ is a maximum radius of a workpiece, and θₘₐₓ is a total angle of a spiral trajectory;
Step 1-2, performing an initial sampling at equal-angle Δθ under a premise of satisfying a trajectory target error Δzₜₒₗ, then obtaining an initial trajectory point set [symbol] :
$$𝒫 = {\{ ( {ρ}_{i} , {θ}_{i} , {z}_{i} ) \}}_{i = 1}^{N} , f ( {ρ}_{i} cos {θ}_{i} , {ρ}_{i} sin {θ}_{i} )$$
Wherein ρᵢ is a radial coordinate of an initial trajectory point, θᵢ is a polar angle of the initial trajectory point, zᵢ is a sagittal height of the initial trajectory point, and N is a number of initial equal-angle sampling points.

3. The trajectory optimization method for STS turning of complex curved surfaces based on curvature gradient clustering and trajectory error constraints according to claim 1, wherein a calculation formula for a probability density function estimate \hat{p}_{G}(g) is as follows:
$${\hat{p}}_{G} ( g ) = \frac{1}{nh} {\sum }_{i = 1}^{n} K ( \frac{g - {G}_{i}}{h} )$$
Wherein g is a curvature gradient value at which the probability density is currently being estimated; n is total number of samples in a curvature gradient sequence; Gᵢ is a curvature gradient value at an i-th sample point;
$$K ( \frac{g - {G}_{i}}{h} )$$
is a kernel function; and h is a bandwidth.

4. The trajectory optimization method for STS turning of complex curved surfaces based on curvature gradient clustering and trajectory error constraints according to claim 3, wherein a
$$K ( \frac{g - {G}_{i}}{h} ) = \frac{1}{\sqrt{2 π}} {e}^{- {u}^{2} / 2} ,$$
h=1.06σ_{G}n^{-1/5}, and σ_{G} is a standard deviation of the curvature gradient samples.

5. The trajectory optimization method for STS turning of complex curved surfaces based on curvature gradient clustering and trajectory error constraints according to claim 1, wherein the specific steps of Step 5 are as follows:
Step 5-1, after completing point deletion in flat regions, performing a global error validation on an entire optimized trajectory point set, if there exists a set of out-of-tolerance positions Θₒᵥₑᵣ={θ:E(θ)>Δzₜₒₗ}, mapping these out-of-tolerance θ positions to their corresponding optimized point intervals [θₖ, θₖ₊₁];
Step 5-2, for each identified interval, dynamically determining a number of points ins, k according to its local maximum out-of-tolerance E_{max,k}, and uniformly inserting these points within the interval to encrypt a grid;
Step 5-3, repeating a global validation-local encryption process until the global error satisfies max E(θ)≤Δzₜₒₗ.

6. The trajectory optimization method for STS turning of complex curved surfaces based on curvature gradient clustering and trajectory error constraints according to claim 1, wherein in Step 6, outputting a final optimized trajectory point set
$${𝒫}_{o p t} = {\{ ( {ρ}_{i}^{o p t} , {θ}_{i}^{o p t} , {z}_{i}^{o p t} ) \}}_{i = 1}^{{N}_{o p t}} ,$$
wherein
$${ρ}_{i}^{o p t}$$
is a radial coordinate of the optimized trajectory point,
$${θ}_{i}^{o p t}$$
is a polar angle of the optimized trajectory point, and
$${z}_{i}^{o p t}$$
is a sagittal height of the optimized trajectory point.
